(19) United States
(12) Patent Application Publication
(10) Pub. No.: US 2007/0240821 A1
(43) Pub. Date: Oct. 18, 2007

(54) METHOD FOR HAND IRONING FOR IMAGE TRANSFER SHEETS

(75) Inventors: Stephen Xipeng Liu, East Providence, RI (US); Zhong Xu, Holden, MA (US)

Correspondence Address: BARLOW, JOSEPHS & HOLMES, LTD., 101 DYER STREET, 5TH FLOOR, PROVIDENCE, RI, 02903, US

(73) Assignee: ARKWRIGHT, INC., Fiskeville, RI (US)

(21) Appl. No.: 11/735,193

(22) Filed: Apr. 13, 2007

Related U.S. Application Data
(60) Provisional application No. 60/745,044, filed on Apr. 18, 2006.

(51) Int. Cl. B32B 37/00

(52) U.S. Cl. 156/309.9

(57) ABSTRACT

The present invention provides an ironing process which transfers an image from an imaged transfer sheet, having a front imaged surface and a back surface, a top edge, a bottom edge and two side edges, onto a receptor element to produce an imaged receptor element. The ironing process comprises: (1) ironing a first half sheet of the imaged transfer sheet until the image is transferred for about 1 minute to about 5 minutes, preferably 1 minute and 30 seconds; and (2) then ironing the second half sheet of the imaged transfer sheet for about 1 minute to about 5 minutes, preferably 1 minute and 30 seconds, until the image is transferred.

### CROSS-REFERENCE TO RELATED APPLICATION

This Application is related to and claims priority from earlier filed Provisional Patent Application Ser. No. 60/745,044, filed Apr. 18, 2006 and incorporated herein by reference.

### BACKGROUND OF THE INVENTION

1. Field of the Invention

The present invention relates to a process for transferring an image from a transfer sheet onto a receptor using a hand iron. The process provides for an improved transfer performance.

2. Description of the Prior Art

Textiles such as shirts (e.g., tee shirts) having a variety of designs thereon have become very popular in recent years. These designs may be transferred to a fabric or textile using a professional or commercial transfer apparatus, such as a commercial heat press. Alternatively, the consumer can separately purchase the fabric and pre-imaged transfer sheets or transfer sheets to be imaged by the consumer, decorate (e.g. image) the transfer sheet at home, and transfer the image to the fabric by using a hand iron.

Imaged transfer sheets, which are to be applied onto fabrics, are known in the art. The support for the transfer is of conventional design and well known to those skilled in the art. The image includes indicia from simple one-color block letters to elaborate multi-color illustrations. The transfer sheets also come in various sizes, and suitable transfer layers are known in the art.

To apply an image from a transfer sheet to a receptor (e.g. fabric), a heated iron or press is typically used. The transfer sheet containing the image to be transferred is placed on the receptor (e.g. T-shirt) such that the imaged side of the transfer sheet is in contact with the receptor. Heat is then applied to the transfer sheet on the side opposite of the imaged side (e.g. backside), allowing the transfer layer to melt, thereby releasing the image and transfer material from the transfer sheet, and to flow onto the receptor. The support of the transfer sheet is removed from the receptor leaving behind the transfer layer and image.

A variety of transfer processes have been described in the prior art and in commercially available products. For example, U.S. Pat. No. 3,985,602 to Stuart describes processes for transferring images from a paper sheet to another sheet that may be a fabric. The Stuart patent describes a composite sheet, which incorporates a paper carrier sheet with a transparent, thermoplastic sheet, and having an image retaining, pressure sensitive adhesive layer. The composite sheet is placed against a printed image on paper, and the pressure sensitive adhesive holds the image while the original paper backing is dissolved away by water. A source of heat, such as an iron, is used to cause a melting of the thermoplastic layer whereby the plastic, with the adhesive and the image are bonded to a fabric such as a shirt. Then, the paper carrier is removed.

In U.S. Pat. No. 5,133,819 to Croner, a process for reproducing a source image on a fabric is described. In this process, a transfer fabric containing the image to be transferred is placed on a receiving fabric so that a heat-activated adhesive on the image is in contact with the receiving fabric. The transfer fabric and adhesive are then heated so that the image is transferred to the receiving fabric.

In U.S. Pat. No. 6,539,652, incorporated herein by reference, a process for transferring an image onto a fabric is described. In this process, an imaged transfer sheet is placed face down with the imaged side in contact with fabric. A heated iron is applied to the back non-imaged surface of the transfer sheet. FIGS. 1A and 1B of the patent demonstrate the full sheet ironing method of U.S. Patent No. 6,539,652. The process starts at one corner point of the transfer sheet and moving to one opposite corner along one side in one pass for 15 sec.-2 min., and then repeating additional parallel passes to cover the whole transfer sheet. The process then starts at one corner point of the transfer sheet and moving to one opposite corner in a direction, which is substantially perpendicular to the first portion's ironing direction, and then repeating additional parallel passes to cover the whole transfer sheet. After the full sheet ironing, the transfer sheet is allowed to cool down, followed by removing the carrier paper. The image is to some extent transferred to fabric.

Many image-transfer kits that are commercially available to the consumer include a transfer sheet and instructions for printing and transferring the design onto the desired article of clothing. For example, Canon includes instructions for “T-Shirt Transfers TR-201” which directs the consumer to transfer a small design to a T-shirt by ironing around the edges of the design, and then ironing over the entire design for approximately 20 seconds. When larger designs are being transferred, the consumer is instructed to iron from top to bottom for 10 to 15 seconds, repeating the process six to eight times, and then iron from side to side for four to six repetitions of 15 to 20 seconds each. Finally, the consumer should iron around the edge of the transfer sheet for 30 to 40 seconds. The transfer sheet and T-shirt are cooled for one to two minutes before removing the transfer sheet.

A similar set of instructions for a Hewlett-Packard® T-shirt transfer kit directs the consumer to iron from side to side for one minute at one edge of the transfer sheet, and repeat the process at the opposite edge. This is followed by ironing in large circles around the entire sheet for one minute. The printed transfer is cooled for at least five minutes before the transfer sheet is removed.

Epson sells iron-on transfers with instructions to first iron over the long side of the transfer sheet, and then iron over the opposite side two times, followed by ironing in a circular motion over the entire sheet. The total ironing process should take at least two to three minutes. The transfer sheet is peeled off while hot.

An image transfer kit sold by Kodak uses an ironing process wherein the consumer irons for 30 seconds per area in the following order: from the upper left to the upper right, from the lower left to the lower right, from the upper left to the upper right, from the lower left to the lower right, then three times circularly along the outer edges. The printed transfer is cooled for one minute before removing the transfer sheet.

In a separate image transfer kit sold by Kodak, the consumer irons for 30 seconds per area in the following order: from upper left to upper right, from middle left to middle right, from lower left to lower right, from upper left to upper right, from middle left to middle right, from lower left to lower right, circularly over the outer edges, and then over the entire transfer.

Avery sells a T-shirt transfer kit with instructions that direct the consumer to iron one area of the transfer sheet, pressing for 10 to 20 seconds per area until the entire transfer sheet has been heated. This is followed with a circular ironing step which covers the transfer sheet. The printed transfer is cooled completely before the transfer sheet is removed.

Hammermill Papers sells cool-peel iron-on transfers, marketed under the name Invent it!™. The instructions for transferring an image include ironing from lower left to upper left for 15 seconds, ironing from lower right to upper right for 15 seconds, then ironing in circles, at two to three seconds per circle, for two minutes. The printed transfer is cooled completely (“cold peel”).

Copy Trans Ink Jet™ sells transfers for T-shirts, which are transferred by ironing over the entire transfer for 15 to 20 seconds per position, followed by ironing in a circular motion. The transfer sheet is removed while hot (“hot peel”).

The instructions included with Hewlett-Packard® Iron-on Transfers for White Fabric direct consumer to place the transfer sheet with the printed side against the fabric and the back of the transfer paper facing up, begin to iron at one edge of the transfer sheet, using several parallel passes a few inches apart, ironing for 20 seconds on each pass, making 4 or 5 iron passes for a full-page transfer sheet, then iron with parallel passes from the other side. The transfer sheet is removed after it is cooled for at least 1 minute. The ironing method shown in the instructions is similar to the ironing method shown in FIGS. 1A and 1B of U.S. Pat. No. 6,539,652.

The disadvantage of all of these methods is that the transferred image is often not completely transferred to the fabric, leaving portions of the image on the transfer sheet upon removal of the sheet from the fabric or has poor durability upon washing, commonly referred to as “washability”. The present invention provides an improved ironing technique for image transfer sheets resulting in improved image transfer to a receptor element, e.g., fabric, and improved washability of the imaged receptor element, e.g., imaged fabric, with less cracking and falling off of the transferred image after washing.

### SUMMARY OF THE INVENTION

The present invention provides an ironing process which transfers an image from an imaged transfer sheet, having a front imaged surface and a back surface, a top edge, a bottom edge and two side edges, onto a receptor element to produce an imaged receptor element. The ironing process comprises: (1) ironing a first half sheet of the imaged transfer sheet until the image is transferred for about 1 minute to about 5 minutes, preferably 1 minute and 30 seconds; and (2) then ironing the second half sheet of the imaged transfer sheet for about 1 minute to about 5 minutes, preferably 1 minute and 30 seconds, until the image is transferred. During the individual half sheet ironing steps, there is preferably at least about one inch of an overlapping ironing area at the middle of the imaged transfer sheet where the ironing of the first half sheet overlaps with the ironing of the second half sheet that form the full transfer sheet.

In one embodiment the ironing process of this invention may comprise an optional pre-image transfer step that involves ironing smoothly over the full transfer sheet with minimal pressure, e.g., the pressure provided by the weight of the iron or minimal pressure, for about 10 to about 20 seconds to provide an initial adhesion between said full sheet and the receptor element. In another embodiment, the instant half-sheet ironing technique may follow a full sheet ironing method to improve the image transfer to the receptor element. For example, the instant half-sheet ironing technique may be used after completing the ironing technique of U.S. Pat. No. 6,539,652 to improve the washability of the imaged receptor element.

The half-sheet ironing technique of the instant invention can be conducted by visually approximating the half-sheet portion to be ironed during each half-sheet ironing step of the ironing technique. This approximation will be sufficiently accurate in most image transfers. Alternatively, a line may be provided on the back surface of the transfer sheet, which divides the back of the transfer sheet into two half-sheet portions that are individually ironed according to the instant invention. This line indicating the half sheet separation of the transfer sheet for the half-sheet ironing method can be provided by printing, scoring or marking on the back of the transfer sheet or may be provided during the manufacture of the sheet. In the embodiment where the transfer sheet is transparent the line can be provided on either side of the transfer sheet so long as there is an indication on the back surface of the transfer sheet that indicates it is the surface to be ironed.

Although the half-sheet ironing technique of the instant invention is preferably conducted with the half-sheet being the half sheet measured along the larger dimension of the sheet, the half sheet can be selected in either direction of the full sheet. For example, for a standard size for a transfer sheet of 8.5 inches by 11 inches the half sheet is preferably a half sheet having the dimensions 8.5 inches by 5.5 inches. The half sheet can be selected to run in the other direction and have a dimension of 4.25 inches by 11 inches for a standard 8.5 inch by 11 inch transfer sheet.

In one embodiment of the present invention, Method A comprises: (a) positioning an imaged transfer sheet with the front imaged surface of the transfer sheet in contact with the receptor element; (b) applying a heated iron to about half of the back non-imaged surface of the transfer sheet at a first starting position at a bottom side edge of the transfer sheet; (c) moving the iron in one pass in a path from said bottom side edge of the transfer sheet, along the side edge of the transfer sheet, towards the opposite top side edge of the transfer sheet, completing the pass in about 10 seconds to about 2 minutes; (d) repeating the pass of step (c) at least one additional time while moving the first starting position of the iron towards the center of the bottom edge of the transfer sheet with each repetition, until covering about half of the whole imaged sheet, wherein each subsequent pass overlaps the path of the previous pass; (e) repeating steps (c) through (d) on the ironed half sheet until the total ironing time for said ironed half sheet is 1 minute to about 5 minutes, preferably 1 minute and 30 seconds; (f) applying a heated iron to the back non-imaged surface of the second non-ironed half of the transfer sheet at a second starting position at the center of the bottom edge; (g) moving the iron in one pass in a path from said center of the bottom edge of the transfer sheet, towards the opposite top edge of the transfer sheet, in a direction parallel to one side edge, completing the pass in about 10 second to about 2 minutes; (h) repeating the pass of step (g) at least one additional time while moving the second starting position of the iron towards the not-yet-ironed bottom side edge of the transfer sheet with each repetition until covering all not-yet-ironed half sheet; (i) repeating the ironing of (f) through (h) until the total ironing time for this second half sheet is about 1 minute to about 5 minutes, preferably 1 minute and 30 seconds. There is preferably at least a one inch area at the middle of the imaged transfer sheet where the ironed area of first half sheet overlaps with the ironed area of second half sheet. After the two half sheets have been individually ironed, the transfer sheet may be removed from the image receptor element. The transfer sheet may be removed while hot (“hot peel”) or after cooling (“cold peel”) depending on the characteristics of the transfer sheet.

In another embodiment of the present, there is provided Method B which is a method of transferring an image from an imaged transfer sheet, having a front imaged surface and a back non-imaged surface, a top edge, a bottom edge and two side edges, onto a receptor element to produce an imaged receptor element, wherein the method comprises: (a) positioning an imaged transfer sheet with the front imaged surface of the transfer sheet in contact with the receptor element; (b) applying a heated iron to a first half portion of the back non-imaged surface of the transfer sheet at a first starting position at a bottom side edge of the transfer sheet; (c) moving the iron in one pass in a path from said bottom side edge of the transfer sheet, along the side edge of the transfer sheet, towards the opposite top side edge of the transfer sheet, completing the pass in about 10 seconds to about 2 minutes; (d) repeating the pass of step (c) at least one additional time while moving the first starting position of the iron towards the center of the bottom edge of the transfer sheet with each repetition, until covering about half of the whole imaged sheet, wherein each subsequent pass overlaps the path of the previous pass; (e) applying a heated iron to the back surface of the ironed half sheet at a second starting position at the top side edge of the transfer sheet; (f) moving the iron in one pass in a path from said top side edge of the transfer sheet, along the top edge of the transfer sheet, towards the opposite top side edge, until reaching approximately the center point of the top edge of the imaged transfer sheet, completing the pass in about 10 seconds to about 2 minutes; (g) repeating the pass of step (f) at least one additional time while moving the second starting position of the iron towards the bottom side edge, wherein each subsequent pass overlaps the path of the previous pass; (h) applying a heated iron to the second half portion back non-imaged surface of the transfer sheet at a third starting position at the middle of the bottom side edge of the second half portion of the transfer sheet; (i) moving the iron in one pass in a path from said bottom side edge of the transfer sheet, towards the opposite top side edge of the transfer sheet, completing the pass in about 10 seconds to about 2 minutes; (j) repeating the pass of step (i) at least one additional time while moving the third starting position of the iron towards the not-yet-ironed side bottom edge of the transfer sheet with each repetition, wherein each subsequent pass overlaps the path of the previous pass; (k) applying a heated iron to the back surface of the ironed second half sheet at a fourth starting position at the middle of the top side edge of the transfer sheet; (l) moving the iron in one pass in a path from said middle of the top side edge of the transfer sheet, along the top edge of the transfer sheet, towards the not-yet-ironed top side edge, completing the pass in about 10 seconds to about 2 minutes (m) repeating the pass of step (l) at least one additional time while moving the forth starting position of the iron towards the bottom side edge, wherein each subsequent pass overlaps the path of the previous pass. There is preferably at least a one-inch area at the middle of the imaged transfer sheet where the ironed area of first half sheet overlaps with the ironed area of second half sheet. After the two half sheets have been individually ironed, the transfer sheet may be removed from the image receptor element. The transfer sheet may be removed while hot (“hot peel”) or after cooling (“cold peel”) depending on the characteristics of the transfer sheet.

In another embodiment of the present, there is provided Method C which is a method of transferring an image from an imaged transfer sheet, having a front imaged surface and a back non-imaged surface, a top edge, a bottom edge and two side edges, onto a receptor element to produce an imaged receptor element, wherein the method comprises: (a) positioning an imaged transfer sheet with the front imaged surface of the transfer sheet in contact with the receptor element; (b) applying a heated iron to the back surface of the transfer sheet at a first starting position at the middle of the bottom edge; (c) moving the iron in a circular manner to cover a first half sheet of the imaged transfer sheet until said first half sheet is fully heated, completing in 1 minute to about 5 minutes, preferably 1 minute and 30 seconds; (d) repeating step (b); (e) moving the iron in a circular manner in a counter-direction of step (c) to cover the second half sheet of the imaged transfer sheet until said second half sheet is fully heated, completing in 1 minute and about to 5 minutes, preferably 1 minute and 30 seconds. There is preferably at least a 1 inch area where the first ironed half sheet overlaps with the second ironed half sheet of the imaged transfer sheet. There is preferably at least a one inch area at the middle of the imaged transfer sheet where the ironed area of first half sheet overlaps with the ironed area of second half sheet. After the two half sheets have been individually ironed, the transfer sheet may be removed from the image receptor element. The transfer sheet may be removed while hot (“hot peel”) or after cooling (“cold peel”) depending on the characteristics of the transfer sheet.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A is a diagram of the ironing method corresponding to steps (b)-(e) of Method A.

FIG. 1B is a diagram of the ironing method corresponding to steps (f)-(i) of Method A.

FIG. 2A is a diagram of the ironing method corresponding to steps (b)-(d) of Method B.

FIG. 2B is a diagram of the ironing method corresponding to steps (e)-(g) of Method B.

FIG. 2C is a diagram of the ironing method corresponding to steps (h)-(j) of Method B.

FIG. 2D is a diagram of the ironing method corresponding to steps (k)-(m) of Method B.

FIG. 3A is a diagram of the ironing method corresponding to steps (b)-(c) of Method C.

FIG. 3B is a diagram of the ironing method corresponding to steps (d)-(e) of Method C.

### DETAILED DESCRIPTION OF THE PREFERRED EMBODIMENTS

### 1. Transfer Sheet

Suitable transfer sheets include any heat-activated transfer sheet designed for use with a hand iron or heat press, including the sheets discussed in the description of the prior art. Additionally, the transfer sheets disclosed in U.S. Pat. Nos. 4,773,953, 4,980,224, 5,271,990, 5,501,902, 5,242,739, 5,139,917, 5,236,801, 5,948,586, 5,798,179, 6,582,803, 6,726,252, 6,855,383, 6,878,227 and 6,565,949 may be employed, which are herein incorporated by reference.

Accordingly, dry release transfer materials per se are well known in the art, and any suitable dry release transfer material may be used in the invention. Canon® creative products T-Shirt Transfers TR-101 may be used. Other suitable transfer materials include a transfer sheet known as “TRANSEEZE” manufactured by Kimberly-Clark Corporation or any other commercially available transfer sheet which has a substrate with a coating which is transferable to a receptor sheet upon the application of heat or pressure to the back of the substrate, and may be coated with, for instance, Singapore Dammar Resin. Also, Cycolor transfer materials as disclosed U.S. Pat. Nos. 5,139,917 and 5,236,801, or silver halide transfer materials as disclosed in U.S. Pat. No. 5,620,548.

If a transfer carrier layer is used in the transfer material, the transfer carrier layer is preferably capable of transfer from the support (e.g. imaging sheet) and adherence to a receptor without the requirement of a separate surface adhesive layer. Without being bound by any theory, upon back surface heating of the half sheet of the transfer sheet and the layers would undergo a solid to solution phase transition resulting in a transfer to the receiving layer. The iron remains directed to a smaller area of the transfer sheet as heat is provided by the iron to the back of the transfer sheet and improves the image transfer to the receptor element. Edge to edge adhesion, to the receiving layer, would occur upon cooling of the carrier onto the receiving layer. Upon cooling, an image layer would be completely transferred onto the receiving layer with an excess of carrier providing mechanical and thermal stability, as well as washability. The transfer carrier layer of the transfer material should provide a colorfast image (e.g. washproof or wash resistant) when transferred to the receptor surface. That is, upon washing the receptor element (e.g. tee shirt), the image should remain intact on the receptor element.

The typical and preferred size of the transfer sheet is either 8.5 inches by 11 inches or A4 size paper (210 mm by 297 mm or 8.27 inches by 11.69 inches).

### 2. Receptor Element

Suitable receptor elements include any receptor element which is capable of receiving the image and transfer layer and withstanding the heat used in the ironing process. For example, textiles or fabrics such as cotton, polyester, and cotton/polyester blend fabrics may be used. Optionally, the fabric may be ironed prior to the transfer process in order to remove moisture and/or wrinkles from the fabric.

### 3. Method

In the process of the invention it is preferable that the hand iron 2 be set at a temperature of at least 330 degree. F., more preferably 356 degree. F. Typically, the iron 2 should be set at the maximum cotton temperature setting. It is further preferred that the steam setting of the iron 2 not be used. For best results, the receptor element to which the image is being transferred should be on a flat surface and should be smoothed to eliminate any wrinkles prior to the transfer process.

The imaged transfer sheet 1 is placed image side down on the receptor element to be decorated. The user should iron slowly but firmly according to the present technique, and should ensure that the entire transfer sheet 1 has been heated by heating each half sheet according to the instant method. While the iron 2 is in contact with the transfer sheet 1, it is preferred that the iron 2 be kept in constant motion. Once the ironing steps for each half sheet are complete, it is preferable that the transfer sheet 1 be allowed to cool for approximately one minute before it is peeled away from the imaged receptor element. It is further preferred that the transfer sheet 1 be allowed to cool completely before peeling the transfer sheet 1 away from the imaged receptor element. Preferably, the transfer sheet 1 is peeled away from the imaged receptor element starting with one corner and peeling the sheet diagonally towards the opposite corner until the entire transfer sheet has been removed.

Preferably, the iron 2 is moved either substantially parallel or substantially perpendicular to the longitudinal axis of the iron 2. Conventional irons have a heating element shape which approximates an isosceles triangle. In such an iron 2, the longitudinal axis is the axis of symmetry which bisects the isosceles triangle into two identical right triangles,

The length of time for each pass over each half sheet of the transfer sheet is about 10 seconds to 2 minutes and preferably 15 seconds to 2 minutes. More preferably 15 seconds to 1.5 minutes. More preferably 15-45 seconds, and a most preferred length of time is 15-22 seconds. The actual time for each pass over each half sheet is related to the actual selected temperature of the iron 2.

Each pass over the transfer sheet 1 should overlap the path of the previous pass by an amount sufficient to ensure that all areas are heated. For example, the overlap may be four inches or less, preferably two inches or less.

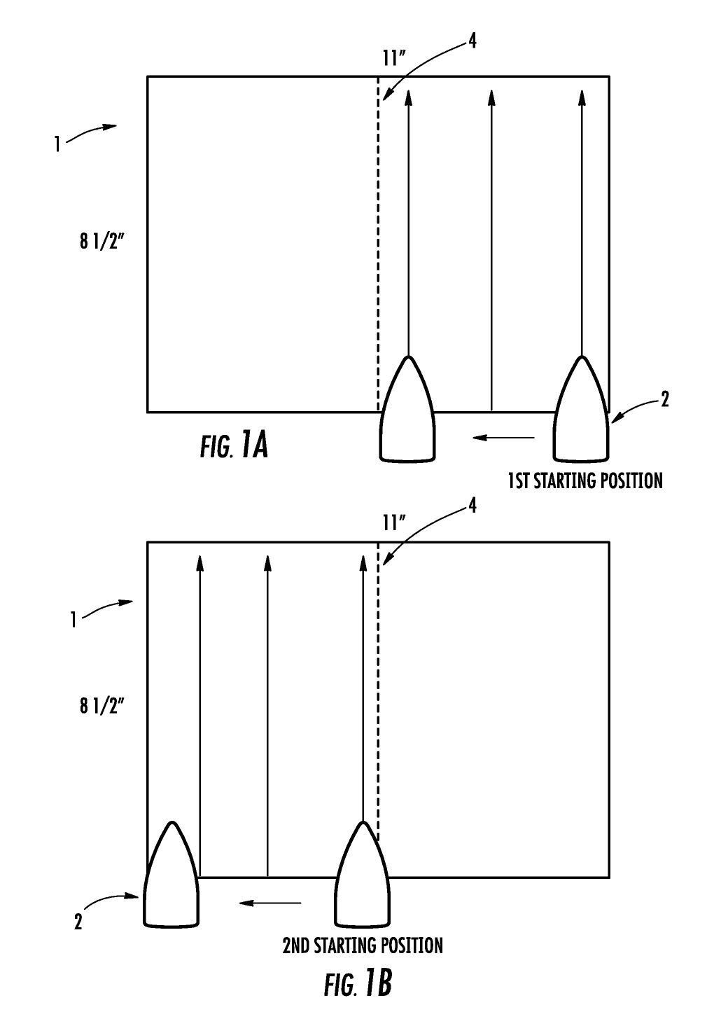

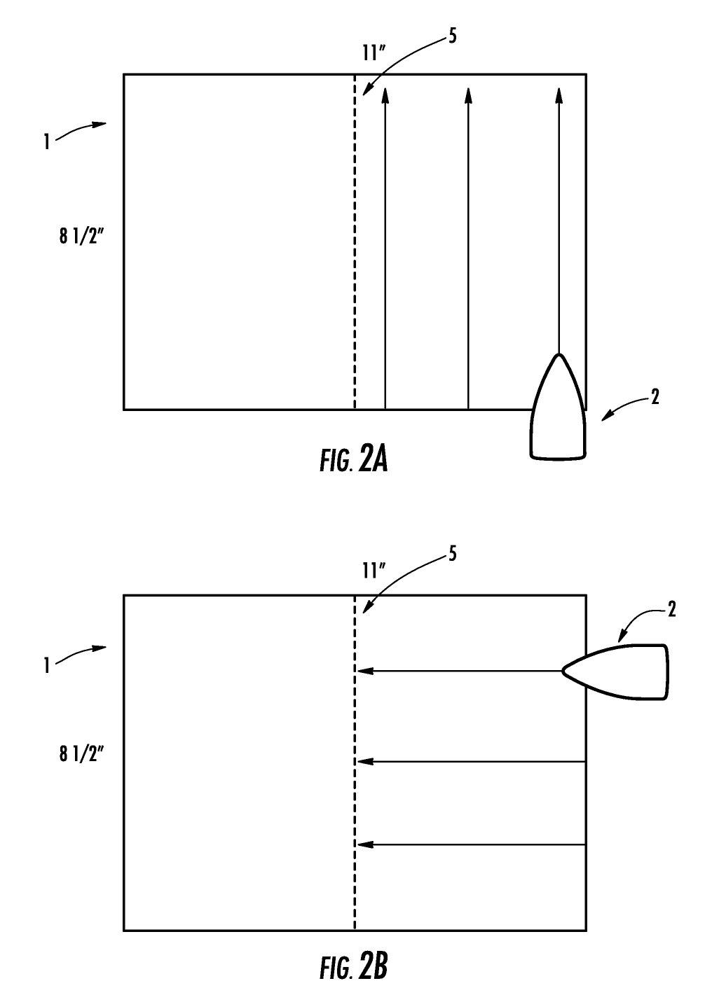

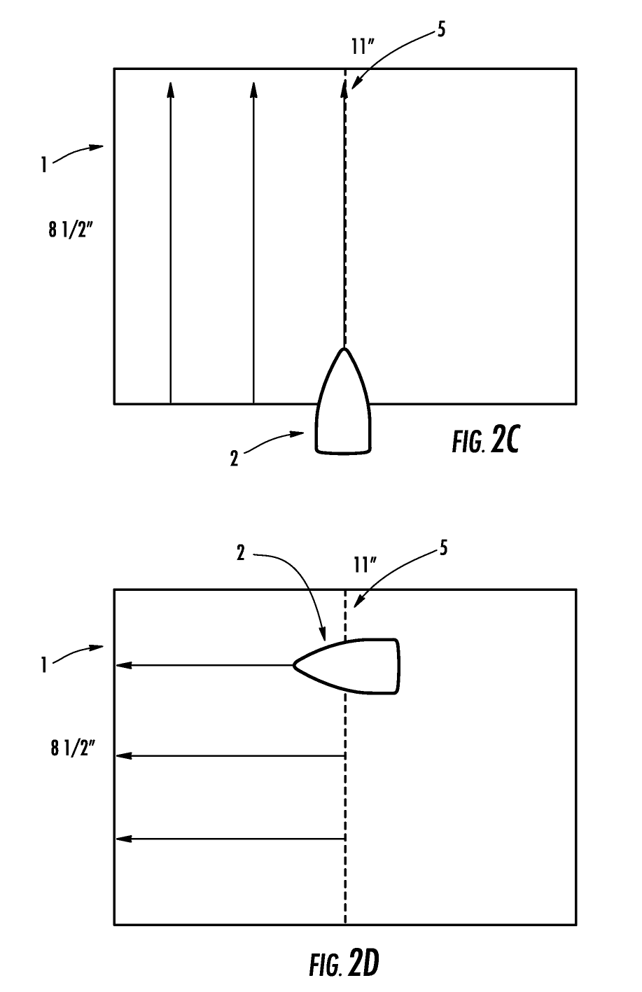

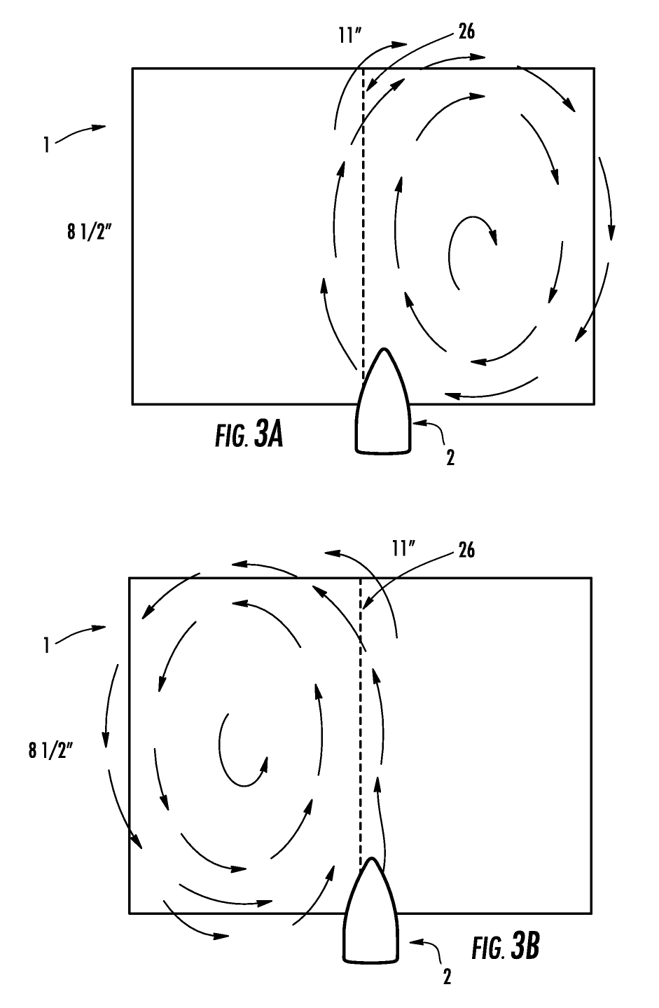

FIG. 1 shows the half sheet ironing method of Method A according to the instant invention. The two half sheets on either side of centerline 4 are separately ironed with an overlapping area of the other half sheet being ironed each half sheet is ironed. This assures that the entire area of the transfer sheet 1 is ironed. FIG. 2 shows the half sheet ironing method of Method B according tot the instant invention. The two half sheets on either side of centerline 5 are separately ironed with an overlapping area of the other half sheet being ironed each half sheet is ironed. This assures that the entire area of the transfer sheet 1 is ironed. FIG. 3 shows the half sheet ironing method of Method C according to the instant invention. The two half sheets on either side of centerline 6 are separately ironed with the circular motion of the iron 2 with an overlapping area of the other half sheet being ironed when each half sheet is ironed. This assures that the entire area of the transfer sheet 1 is ironed,

### EXAMPLES

The transfer technique of Method A of the invention was compared to the ironing image transfer technique described in the Hewlett-Packard Iron-on Transfers for White Fabric insert, a known prior art technique.

### Example 1

Using the Hewlett-Packard (“HP”) Iron-on Transfers for White Fabric technique, an 8½ by 11 inch size sheet of HP Iron-on Transfers for White Fabric ink jet transfer paper was ironed onto a cotton tee-shirt by first ironing for approximately 20 seconds along a shorter edge. This was repeated additional four times as the iron was moved across the length of the paper. Then the transfer was ironed for 20 seconds along a longer edge, repeating additional three times as the iron was moved across the width of the paper. After the transfer sheet had been allowed to cool for approximately 2 minutes, the transfer sheet was pulled away from the tee shirt.

The transfer technique of Method A according to the present invention was then used to transfer an image from an 8½ by 11 inch size sheet of HP Iron-on Transfers for White Fabric ink jet transfer paper onto a cotton tee-shirt. The imaged transfer sheet 1 was positioned with the front imaged surface of the transfer sheet 1 in contact with the tee-shirt. The iron 2 was firmly pressed against the back surface of the transfer sheet 1 at a first starting position at the bottom right edge of the transfer sheet 1. The iron 2 was then moved from bottom to top, as shown in FIG. 1A, making three passes of 15 seconds each while moving the first starting position of the iron 2 towards the middle of the bottom edge with each repetition. Each subsequent pass overlapped the path of the previous pass. These said three passes covered approximately 6-inch length of the total 11-inch length of the ink jet transfer paper. The said three passes were repeated exactly in the same manner one more round with firm pressure. Then the iron 2 was positioned as in shown in FIG. 1B with a firm pressure against the back surface of the transfer sheet 1 at a second starting position at the middle of the bottom edge, where the iron face in contact with the transfer sheet 1 overlaps about one inch with the previous already-ironed half sheet of the transfer sheet 1. The iron 2 was moved from bottom to top, as shown in FIG. 1B, making three passes of 15 seconds each while moving the second starting position of the iron 2 towards the left bottom edge with each repetition. Each subsequent pass overlapped the path of the previous pass. The said three passes were repeated exactly in the same manner one more round with firm pressure. Each half sheet on either side of centerline 4 defining the two half sheets is ironed and a small overlapping area of the other half sheet is ironed when a half sheet is ironed. The total ironing time was 3 minutes. The temperature of the iron 2 was at its maximum cotton setting (approximately 356 degrees F.) in all of the tests. The transfer sheet 1 was then allowed to cool completely before pulling the transfer sheet 1 away from the tee shirt.

A panel of three observers reviewed the results. The imaged tee shirts were then washed one time, and the image was observed by the panel for washability (cracking and adhesion to tee-shirt). Then the imaged tee shirts were washed additional four times, and the image was observed again for cracking and adhesion to tee-shirt. For first washing, the image transferred using the technique of the invention has minor cracking and minor falling off. By comparison, the image transferred using HP iron-on technique has some cracking and some falling off. After five washes, the image using the technique of the invention has some cracking and falling off. By comparison, the image transferred using HP iron-on technique has some cracking and severe falling off. Overall, the image using the technique of the invention has less falling off and adheres better to the tee shirt than using the HP Iron-on Transfers for White Fabric technique. The results are tabulated as follows:

TABLE 1

| Property | Invention³ | HP Iron-on⁴ |
|---|---|---|
| Cracking¹ after 1^{st} washing | 0 | − |
| Adhesion² after 1^{st} washing | 0 | − |
| Cracking¹ after 5^{th} washing | − | − |
| Adhesion² after 5^{th} washing | − | −− |

¹Cracking after washing: + no cracking of the image; 0 minor cracking of image; − some cracking of image; −− severe cracking of image
²Adhesion after washing: + no falling off; 0 minor falling off; − some falling off; −− severe falling off
³Half Sheet Ironing Method using HP Iron-On Transfer Sheets
⁴HP Iron-On Method using HP Iron-On Transfer Sheets

### The results in Table 1 demonstrate an improved transfer performance when using the half sheet ironing technique of the instant invention.

### Example 2

The same procedure was followed as for Example 1, with the exception that the transfer paper used was a commercially available product sold as Avery® Light Fabric transfer paper sheets. The results are tabulated as follows:

TABLE 2

| Property | Invention³ | HP Iron-on⁴ |
|---|---|---|
| Cracking¹ after 1^{st} washing | + | 0 |
| Adhesion² after 1^{st} washing | + | + |
| Cracking¹ after 5^{th} washing | + | 0 |
| Adhesion² after 5^{th} washing | + | + |

¹Cracking after washing: + no cracking of the image; 0 minor cracking of image; − some cracking of image; −− severe cracking of image
²Adhesion after washing: + no falling off; 0 minor falling off; − some falling off; −− severe falling off
³Half Sheet Iroining Method using Avery ® Light Fabric Transfer Sheets
⁴HP Iron-On Method using Avery ® Light Fabric Transfer Sheets

### The results in Table 2 demonstrate an improved transfer performance when using the half sheet ironing technique of the instant invention.

All cited patents, publications, copending applications, and provisional applications referred to in this application are herein incorporated by reference.

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method of transferring an image from an imaged transfer sheet, having a front imaged surface and a back surface, a top edge, a bottom edge and two side edges, onto a receptor element to produce an imaged receptor element, wherein the method comprises: (1) ironing a first half sheet of the imaged transfer sheet for about 1 minute to 5 minutes, preferably 1 minute and 30 seconds; and 2) ironing the second half sheet of the imaged transfer sheet for about 1 minute to 5 minutes, preferably one minute and 30 seconds.

2. The method according to claim 1 wherein there is at least a one inch area at the middle of the imaged transfer sheet where the said ironed area of said first half sheet overlaps with the said ironed area of said second half sheet.

3. The method according to claim 1 wherein there is a line which marks the middle of the imaged transfer sheet.

4. The method according to claim 1 wherein said after ironing said first half sheet and said second half sheet are cooled.

5. The method of claim 4 wherein said transfer sheet is removed from said receptor element to provide an imaged receptor element.

6. The method of claim 1 wherein said ironing for each half sheet is ironed until the image is transferred to said receptor element.

7. A method of transferring an image from an imaged transfer sheet, having a front imaged surface and a back surface, a top edge, a bottom edge and two side edges, onto a receptor element to produce an imaged receptor element, wherein the method comprises: (a) positioning an imaged transfer sheet with the front imaged surface of the transfer sheet in contact with the receptor element; (b) applying a heated iron to the back non-imaged surface of the transfer sheet at a first starting position at a bottom side edge of the transfer sheet;(c) moving the iron in one pass in a path from said bottom side edge of the transfer sheet, along the side edge of the transfer sheet, towards the opposite top side edge of the transfer sheet, completing the pass in about 10 seconds to about 2 minutes; (d) repeating the pass of step (c) at least one additional time while moving the first starting position of the iron towards the center of the bottom edge of the transfer sheet with each repetition, until covering at least half of the whole imaged sheet, wherein each subsequent pass overlaps the path of the previous pass;(e) repeating steps (c) through (d) on the ironed half sheet until the total ironing time for said ironed half sheet is 1 minute to 5 minutes, preferably 1 minute and 30 seconds, (f) applying a heated iron to the back non-imaged surface of the transfer sheet at a second starting position at the center of the bottom edge, (g) moving the iron in one pass in a path from said center of the bottom edge of the transfer sheet, towards the opposite top edge of the transfer sheet, in a direction parallel to one side edge, completing the pass in about 10 seconds to about 2 minutes; (h), repeating the pass of step (g) at least one additional time while moving the first starting position of the iron towards the not-yet-ironed bottom side edge of the transfer sheet with each repetition until covering all not-yet-ironed half sheet; (i) repeating the ironing of (f) through (h) until the total ironing time for this second half sheet is about 1 minute to 5 minutes, preferably 1 minute and 30 seconds.

8. A method of transferring an image from an imaged transfer sheet, having a front imaged surface and a back surface, a top edge, a bottom edge and two side edges, onto a receptor element to produce an imaged receptor element, wherein the method comprises: (a) positioning an imaged transfer sheet with the front imaged surface of the transfer sheet in contact with the receptor element; (b) applying a heated iron to the back non-imaged surface of the transfer sheet at a first starting position at a bottom side edge of the transfer sheet;(c) moving the iron in one pass in a path from said bottom side edge of the transfer sheet, along the side edge of the transfer sheet, towards the opposite top side edge of the transfer sheet, completing the pass in about 10 seconds to about 2 minutes; (d) repeating the pass of step (c) at least one additional time while moving the first starting position of the iron towards the center of the bottom edge of the transfer sheet with each repetition, until covering at least half of the whole imaged sheet, wherein each subsequent pass overlaps the path of the previous pass;(e) applying a heated iron to the back surface of the ironed half sheet at a starting position at the bottom side edge of the transfer sheet; (f), moving the iron in one pass in a path from said bottom side edge of the transfer sheet, along the bottom edge of the transfer sheet, towards the opposite bottom side edge, until reaching approximately the center point of the bottom edge of the imaged transfer sheet, completing the pass in about 10 seconds to about 2 minutes; (g), repeating the pass of step (f) at least one additional time while moving the first starting position of the iron towards the top side edge, wherein each subsequent pass overlaps the path of the previous pass; (h), do the same to the not-yet-ironed second half sheet of the imaged transfer sheet as done to the already-ironed first half sheet.

9. A method of transferring an image from an imaged transfer sheet, having a front imaged surface and a back surface, a top edge, a bottom edge and two side edges, onto a receptor element to produce an imaged receptor element, wherein the method comprises: (a), positioning an imaged transfer sheet with the front imaged surface of the transfer sheet in contact with the receptor element; (b) applying a heated iron to the back surface of the transfer sheet at a first starting position at the middle of the bottom edge;(c) moving the iron in a circular manner to cover a first half sheet of the imaged transfer sheet until said first half sheet is fully heated, completing in about 1 minute to about 5 minutes, preferably 1 minute and 30 seconds; (d), repeating step (b); (e), moving the iron in a circular manner in a counter-direction of step (c) to cover the second half sheet of the imaged transfer sheet until said second half sheet is fully heated, completing in about 1 minute to about 5 minutes, preferably 1 minute and 30 seconds.

10. A method of transferring an image from an imaged transfer sheet, having a front imaged surface and a back surface, a top edge, a bottom edge and two side edges, onto a receptor element to produce an imaged receptor element, wherein the method comprises: (1) ironing easy and smoothly over the full sheet of the imaged transfer sheet with little pressure for about 10 to about 20 seconds to build up an initial adhesion between the transfer sheet and the receptor element; (2) ironing a first half sheet of the imaged transfer sheet for about 1 minute to about 5 minutes, preferably 1 minute 30 seconds; (3) ironing the second half sheet of the imaged transfer sheet until it is completely done for about 1 minute to about 5 minutes, preferably 1 miute and 30 seconds.

11. The method according to claim 10 wherein there is at least a one inch area at the middle of the imaged transfer sheet where the said ironed area of said first half sheet overlaps with the said ironed area of said second half sheet.

12. The method according to claim 10 wherein there is a line that marks the middle of the imaged transfer sheet.

13. The method according to claim 10 wherein said after ironing said first half sheet and said second half sheet are cooled.

14. The method of claim 10 wherein said transfer sheet is removed from said receptor element to provide an imaged receptor element.

15. The method of claim 10 wherein said ironing for each half sheet is ironed until the image is transferred to said receptor element.

16. A method of transferring an image from an imaged transfer sheet according to claim 8, said image transfer sheet having a front imaged surface and a back non-imaged surface, a top edge, a bottom edge and two side edges, onto a receptor element to produce an imaged receptor element, wherein the method comprises: (a) positioning an imaged transfer sheet with the front imaged surface of the transfer sheet in contact with the receptor element; (b) applying a heated iron to a first half portion of the back non-imaged surface of the transfer sheet at a first starting position at a bottom side edge of the transfer sheet; (c) moving the iron in one pass in a path from said bottom side edge of the transfer sheet, along the side edge of the transfer sheet, towards the opposite top side edge of the transfer sheet, completing the pass in about 10 seconds to about 2 minutes; (d) repeating the pass of step (c) at least one additional time while moving the first starting position of the iron towards the center of the bottom edge of the transfer sheet with each repetition, until covering about half of the whole imaged sheet, wherein each subsequent pass overlaps the path of the previous pass; (e) applying a heated iron to the back surface of the ironed half sheet at a second starting position at the top side edge of the transfer sheet; (f) moving the iron in one pass in a path from said top side edge of the transfer sheet, along the top edge of the transfer sheet, towards the opposite top side edge, until reaching approximately the center point of the top edge of the imaged transfer sheet, completing the pass in about 10 seconds to about 2 minutes; (g) repeating the pass of step (f) at least one additional time while moving the second starting position of the iron towards the bottom side edge, wherein each subsequent pass overlaps the path of the previous pass; (h) applying a heated iron to the second half portion back non-imaged surface of the transfer sheet at a third starting position at the middle of the bottom side edge of the second half portion of the transfer sheet; (i) moving the iron in one pass in a path from said bottom side edge of the transfer sheet, towards the opposite top side edge of the transfer sheet, completing the pass in about 10 seconds to about 2 minutes; (j) repeating the pass of step (i) at least one additional time while moving the third starting position of the iron towards the not-yet-ironed side bottom edge of the transfer sheet with each repetition, wherein each subsequent pass overlaps the path of the previous pass; (k) applying a heated iron to the back surface of the ironed second half sheet at a fourth starting position at the middle of the top side edge of the transfer sheet; (l) moving the iron in one pass in a path from said middle of the top side edge of the transfer sheet, along the top edge of the transfer sheet, towards the not-yet-ironed top side edge, completing the pass in about 10 seconds to about 2 minutes (m) repeating the pass of step (l) at least one additional time while moving the forth starting position of the iron towards the bottom side edge, wherein each subsequent pass overlaps the path of the previous pass.

17. The method according to claim 16 wherein the half sheet is ironed in two different directions with each direction being substantially perpendicular to each other.
